(19) United States
(12) Patent Application Publication
(10) Pub. No.: US 2003/0126014 A1
(43) Pub. Date: Jul. 3, 2003

(54) Option system and the option method of an internet advertisement subscription

(76) Inventor: Sang-Hwan Oh, Seoul (KR)

Correspondence Address: HARNESS, DICKEY & PIERCE, P.L.C., P.O. BOX 828, BLOOMFIELD HILLS, MI, 48303, US

(21) Appl. No.: 10/296,850

(22) PCT Filed: May 15, 2001
(86) PCT No.: PCT/KR01/00781

(30) Foreign Application Priority Data
May 30, 2000 (KR) 2000/29420

(51) Int. Cl. G06F 17/60

(52) U.S. Cl. 705/14; 705/1

(57) ABSTRACT

The present invention provides an option system and an option method of Internet advertisement subscription, comprising a main server including a member DB, an advertisement DB, a service DB, and an advertisement control module; and a settlement system, the main server and the settlement system being capable of controlling advertisements while they are connected to clients via a network, allowing a user to choose whether to view or not view an advertisement.

### FIELD OF THE INVENTION

The present invention relates to an option system and an option method of an Internet advertisement subscription, in which a main server including a member database having a paid member database and an unpaid member database for managing member information, an advertisement database for managing advertisement programs and transmitting advertisements to clients, a service database for managing services to be provided to the clients and transmitting service and an advertisement control module for verifying member information and controlling advertisement, and a settlement system for managing settlement information of members through member information transmitted from the member database of the main server, verifying the settlement information of members and transmitting the settlement information of members to the main server are connected to the clients though a network and control advertisement.

### DESCRIPTION OF THE PRIOR ART

With development of the Internet, economic activities are actively carried out using the Internet, and the number of Internet service providers has been considerably increased.

An Internet advertising market, which is the main source of revenue of Internet service providers, has grown rapidly in comparison with the advertising market of conventional media such as television, newspaper, magazine, etc. In Korea, the Internet advertising market totaled about 37 billion Korean won (hereinafter, “KRW”) in 1999, and is expected to amount to about 70 billion KRW in 2000.

In the Internet advertisement field, along with its growing advertising market, the types of advertisements get diversified. Accordingly, the emergence of diversified Internet advertisements, such as banner advertisements like box advertisements, E-mail advertisements, image advertisements and selection advertisements, causes the clients a problem that the transmission speed is decreased.

Additionally, there occurs another problem that the clients have difficulty in obtaining information from among a large number of advertisements.

Additionally, there occurs still another problem that clients are forced to view the advertisements without any choice to reject them.

### SUMMARY OF THE INVENTION

Accordingly, the present invention, being conceived in view of the above problems of the prior arts, aims to provide a system for choosing to view Internet advertisements, in which a right to choose between the viewing and not viewing of advertisements is provided to a certain client, thereby securing the convenience of a user and providing service without advertisements.

Another object of the present invention is to provide an option system and an option method of Internet advertisement subscription, in which a right to choose viewing or not viewing an advertisement is provided to the clients, that is, paid or excellent members, thereby helping service providers to increase profits in advertising revenues.

Still another object of the present invention is to provide an option system and an option method of Internet advertisement subscription, in which a right to choose viewing or not viewing an advertisement can be obtained by payment of money or cybermoney, thereby providing a right to choose to a user.

Still another object of the present invention is to provide an option system and an option method of Internet advertisement subscription, which helps service providers to increase profits through money users pay for a right to choose viewing or not viewing an advertisement.

In order to accomplish the above objectives, the present invention provides an option system of Internet advertisement subscription, comprising: a main server including a member DB comprised of a paid member DB and an unpaid member DB for managing member information, an advertisement DB for managing advertisement programs and transmitting advertisements to clients, a service DB for managing services to be provided to the clients and transmitting service, and an advertisement control module for verifying member information and controlling advertisement; and a settlement system for managing settlement information of members through member information transmitted from the member DB of the main server, verifying the settlement information of members, and transmitting the settlement information of members to the main server; wherein the main server and the settlement system are connected to the clients though a network and control advertisement.

Preferably, clients access the main server through an access apparatus using the Internet, a Web Television network, a mobile phone network or a similar network.

In addition, the present invention provides an option method of Internet advertisement subscription in a system for choosing to review Internet advertisements in which advertisement is controlled using a network connecting a main server, clients and a settlement system, comprising: an accessing step of the client accessing the main server; a transmission step of the main server transmitting service and advertisements to the clients; a log-in step of each of the clients inputting his information; a verification step of member information being verified in a member DB and a settlement system; a right granting step of the main server granting a right to choose viewing or not viewing an advertisement through an advertisement control module; an advertisement choosing step of the client choosing viewing or not viewing an advertisement; and an advertisement control and service provision step through the advertisement control module according to the advertisement control request of the client and providing the corresponding service.

Preferably, the method further comprises a reception step of the settlement system receiving fees for service without advertisements or points corresponding to the fees if a paid or excellent member client requests service without part or all of advertisements, wherein the main server provides service without part or all of advertisements to the client through the advertisement control module.

Preferably, the method further comprises a service utilization step of the client utilizing service without part or all of advertisements; an advertisement re-viewing request step of the client requesting a re-viewing of advertisements from the main server; a changed information transmission step of transmitting changed information of the client to the settlement system; a changed information processing step of verifying and processing the changed information of the client in the settlement system; and a service-with-advertisement provision step of the main server providing service with advertisements.

Preferably, the method further comprises a service utilization step of the client choosing to view advertisements and utilizing service with advertisements; an advertisement deletion request step of the client requesting deletion of advertisements from the main server; a changed information transmission step of transmitting changed information of the client to the settlement system; a changed information processing step of verifying and processing the changed information of the client in the settlement system; and a service-without-advertisement provision step of the main server providing service without advertisements.

Preferably, the member information verification step comprises an information transmission step of a paid member DB of the member DB transmitting information of a paid member to the advertisement control module; and an information exchange step of the advertisement control module verifying the information of the paid member through information exchange with the settlement system and providing processed service information to the settlement system.

In addition, the present invention provides an option method of Internet advertisement subscription in a system for choosing to view Internet advertisements in which advertisement is controlled using a network connecting a main server, clients and a settlement system, comprising: an accessing step of the client accessing the main server; a transmission step of the main server transmitting service and advertisements to each of the clients; a logging-in step of the client inputting his information; a verification step of member information being verified in a member DB of the main server and the settlement system; and a service-without-advertisement provision step of the main server providing service without part or all of advertisements to paid or excellent members through an advertisement control module.

The preferred construction and various embodiments of the present invention can be clearly understood from the following detailed description.

The above-described option system and option method of Internet advertisement subscription provide a right to choose viewing or not viewing an advertisement to clients.

Additionally, the option system and option method of Internet advertisement subscription in accordance with the present invention can increase transmission speed by deleting advertisements from services.

Additionally, the option system and option method of Internet advertisement subscription in accordance with the present invention can provide easy-to-view service to clients by deleting advertisements from services.

Additionally, the option system and option method of Internet advertisement subscription in accordance with the present invention restricts a right to choose viewing or not viewing an advertisement to part of clients, thereby allowing service providers to maintain advertising profits.

Additionally, in the option system and option method of Internet advertisement subscription in accordance with the present invention, clients can have a right to choose viewing or not viewing an advertisement by paying money or cybermoney.

Additionally, the option system and option method of Internet advertisement subscription in accordance with the present invention help a service provider to obtain profits from money the users pay for a right to choose viewing or not viewing an advertisement.

### BRIEF DESCRIPTION OF THE DRAWINGS

The above and other objectives, features and other advantages of the present invention will be more clearly understood from the following detailed description taken in conjunction with the accompanying drawings, in which:

FIG. 1 is a schematic diagram of the system of Internet advertisement subscription in accordance with an embodiment of the present invention;

FIG. 2 is a conceptual diagram showing the main server of FIG. 1;

FIG. 3 is a flowchart showing the outline of an option method of Internet advertisement subscription;

FIG. 4 is a flowchart showing a relationship between the right to choose to review Internet advertisements according to an embodiment of the present invention and the settlement system;

FIG. 5 is a flowchart showing the first service conversion of the option method of Internet advertisement ssubscription according to the embodiment of the present invention;

FIG. 6 is a flowchart showing the second service conversion of the option method of Internet advertisement subscription according to the embodiment of the present invention;

FIG. 7 is a schematic diagram showing functioning of the advertisement control module of FIG. 3;

FIG. 8a is a view showing a log-in screen displayed at the unpaid member service utilization step of the option method of Internet advertisement subscription in accordance with an embodiment of the present invention;

FIG. 8b is a view showing a service screen with advertisements displayed at the unpaid member service utilization step of the option method of Internet advertisement subscription in accordance with an embodiment of the present invention;

FIG. 9a is a view showing a log-in screen displayed at the paid member service utilization step of the option method of Internet advertisement subscription in accordance with an embodiment of the present invention;

FIGS. 9b and 9c are views showing service choice screens displayed at the paid member service utilization step of the option method of Internet advertisement subscription in accordance with an embodiment of the present invention;

FIGS. 9d and 9e are views showing service screens displayed at the paid member service utilization step of the option method of Internet advertisement subscription in accordance with an embodiment of the present invention;

FIG. 10 is a flowchart showing an outline of the option method of Internet advertisement subscription in accordance with another embodiment of the present invention; and

FIG. 11 is a schematic diagram showing functioning of the advertisement control module of FIG. 10.

### DETAILED DESCRIPTION OF THE PREFERRED EMBODIMENTS

1. Option System of Internet Advertisement Subscription

Below, an option system of Internet advertisement subscription in accordance with an embodiment of the present invention is described in detail, making reference to the accompanying drawings.

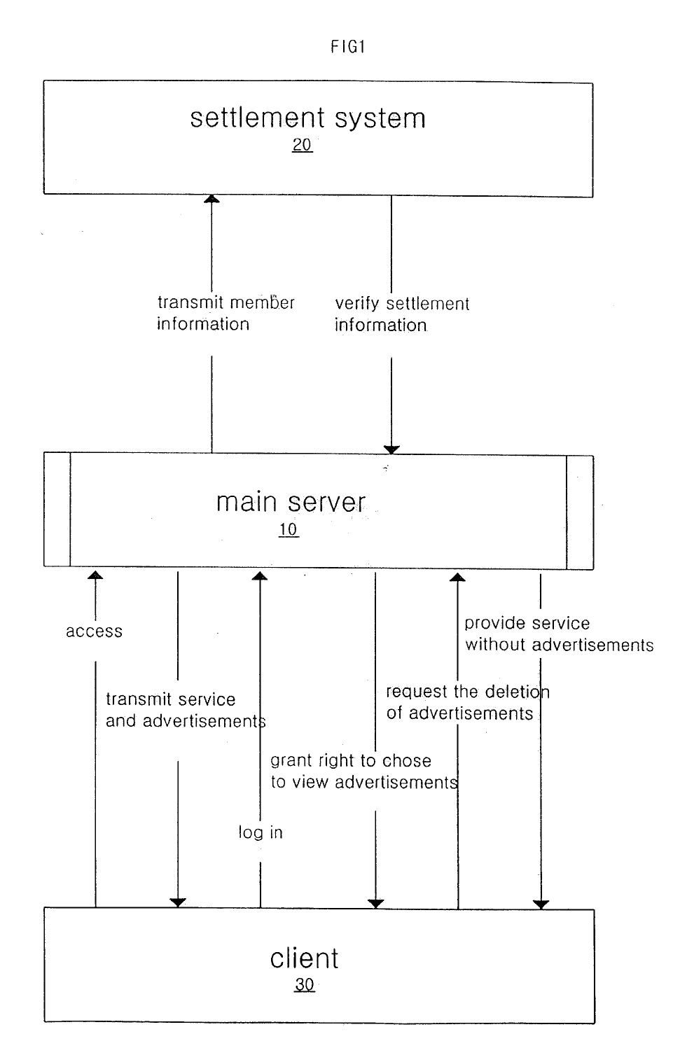

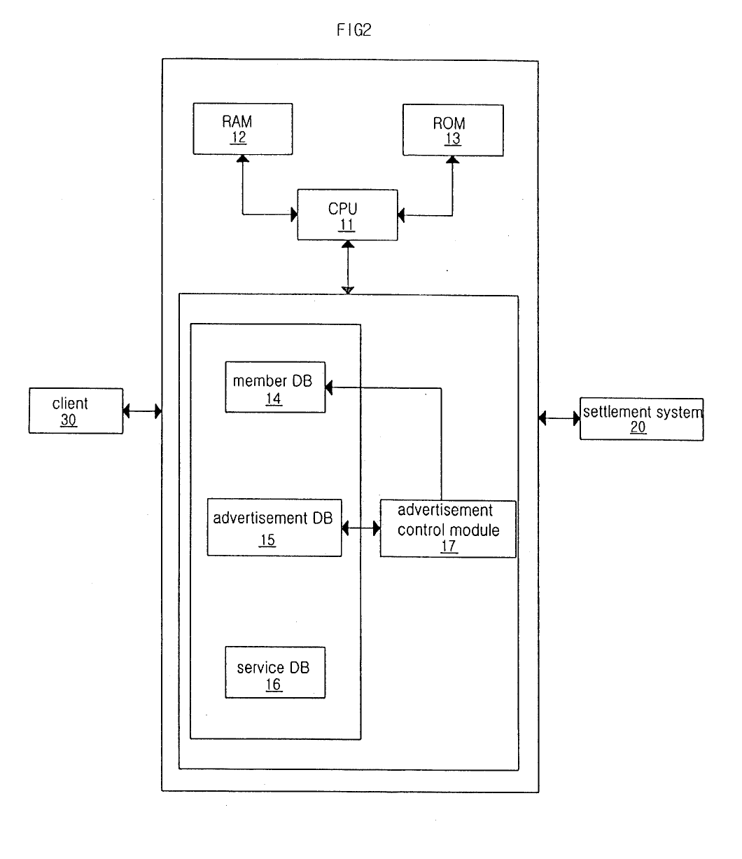

FIG. 1 is a schematic diagram of the option system of Internet advertisement subscription. FIG. 2 is a conceptual diagram showing the main server of FIG. 1.

Referring to FIG. 1, the option system of Internet advertisement subscription has a construction in which a settlement system 20 and a client 30 are connected to each other through a computer network or the like around a main server 10.

Referring to FIG. 2, the main server 10 is connected to the settlement system 20 and the client 30. The main server 10 comprises a basic system including a Central Processing Unit (CPU) 11, a Random Access Memory (RAM) 12 and a Read Only Memory (ROM) 12, a member DataBase (DB) 14, an advertisement DB 15, a service DB 16, and an advertisement control module 17.

DBs that should be provided in the main server 10 are as follows:

1. a member DB 14 for managing member information,

2. an advertisement DB 15 for managing advertisements to be provided to the client 30, and

3. a service DB 16 for managing services to be provided to the client 30.

An advertisement control module 17 functions to control advertisements by controlling in conjunction with the advertisement DB 15 through member information of the client 30.

Referring again to FIG. 1, the settlement system 20 manages settlement information of members through member information transmitted from the member DB 14 of the main server 10, verifies settlement information of the members, and transmits settlement information of the members to the main server 10.

The option system of Internet advertisement subscription is generally described making reference to FIG. 1. The client 30 accesses the main server 10 (1), whereupon the main server 10 provides service and advertisements to the client 30 (2). When the client 30 logs in (3), the main server 10 transmits member information of the client 30 to the settlement system 20 (4). The settlement system 20 verifies member information received from the main server 10, and provides settlement information of the client 30 to the main server 10 (5). The main server 10, having verified settlement information of the client 30, grants a right to choose to view Internet advertisements to the client 30 (6). If the client 30 requests deletion of advertisements from the main server 10 (7), the main server 10 provides service without part or all of advertisements.

2. Option Method of Internet Advertisement Subscription

Now, the method of choosing to review Internet advertisements in accordance with preferred embodiments of the present inventions is described in detail, making reference to the accompanying drawings.

Embodiment 1

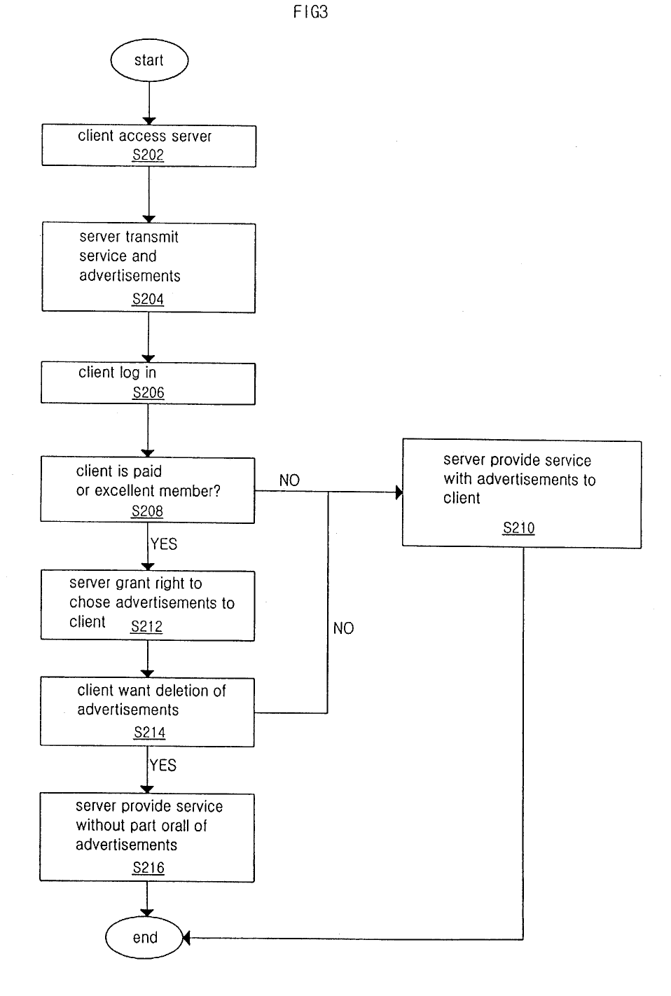

FIG. 3 is a flowchart showing the outline of an option method of Internet advertisement subscription.

Referring to FIG. 3, if the client 30 accesses the main server 10 (S206), the main server 10 transmits service and advertisements (S204). If the client 30 logs in (S206), member information of the client 30 is verified through the main server 10 and the settlement system 20 (S208). If the client 30 is an unpaid member, service with advertisements is provided (S210); while a right to choose viewing or not viewing an advertisement is granted to the client, if the client 30 is a paid or excellent member (S212). If the client 30 wants to delete part or all of advertisements (S214), service without part or all of advertisements is provided to the client 30 (S216); while service with advertisements is provided, if the client 30 does not want deletion of advertisements (S210).

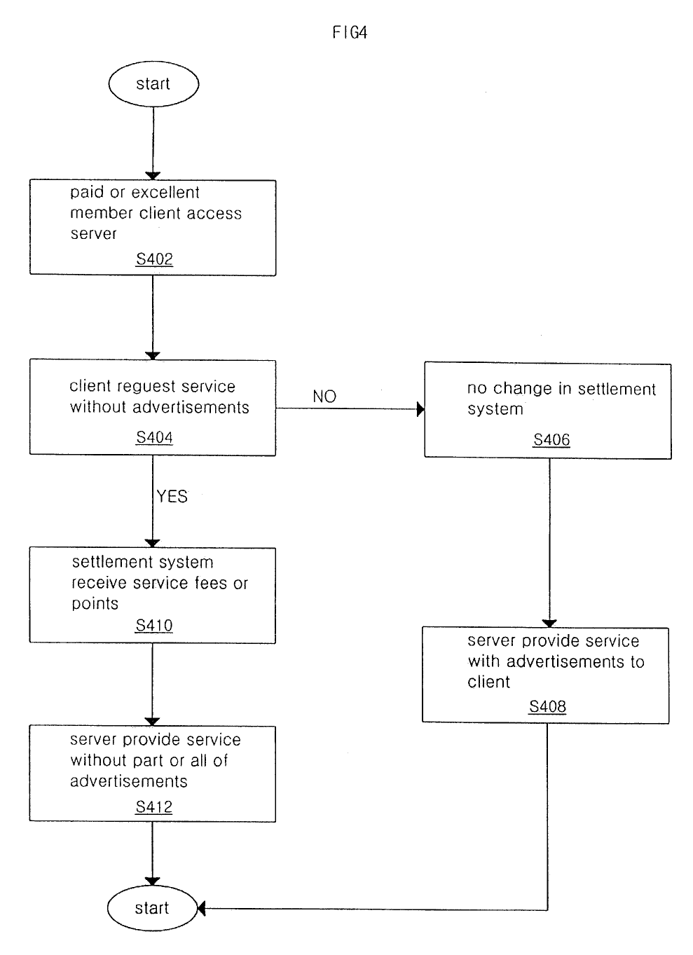

FIG. 4 is a flowchart showing a relationship between the right to choose to view Internet advertisements and the settlement system according to an embodiment of the present invention.

The client 30, who is a paid or excellent member, logs in, and is granted a right to choose viewing or not viewing an Internet advertisement through verification of his member information (S402). If the client 30 does not want service without all or part of advertisements (S404), the main server 10 provides service with advertisements while the settlement status of the client 30 is not varied in the settlement system 20 (S406) (S408). If the client 30 wants deletion of part or all of advertisements (S404), the settlement system 20 receives fees for the service the client 30 requested or points corresponding to the value of the fees (S410), and provides service without part or all of advertisements.

FIG. 5 is a flowchart showing the first service conversion of the option method of Internet advertisement subscription according to an embodiment of the present invention.

If client 30 utilizes service without part or all of advertisements (S602) and does not want current service to be converted into service with advertisements (S604), the state of settlement is not changed in the settlement system 20 (S606). If the client 30 wants current service to be converted to service with advertisements (S604), the main server 10 transmits information of the client 30 to convert service to the settlement system 20 (S608). After the settlement system 20 has processed settlement matters regarding conversion of the service (S610), the main server 10 provides service with advertisements to the client 30 (S612).

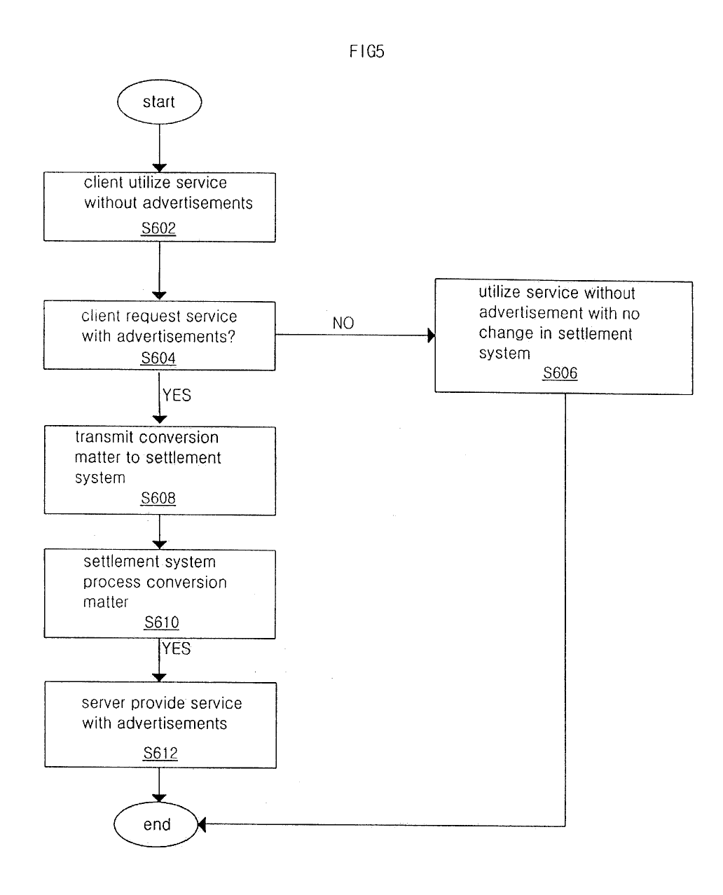

FIG. 6 is a flowchart showing the second service conversion of the option method of Internet advertisement subscription according to an embodiment of the present invention.

If client 30 utilizes service with advertisements (S802) and does not want current service to be converted into service without part or all of advertisements (S804), the state of settlement in the settlement system 20 is not changed (S806). If the client 30 wants current service to be converted to service without part or all of advertisements (S804), the main server 10 transmits information of the client 30 to convert service to the settlement system 20 (S808). After the settlement system 20 has processed settlement matters regarding conversion of the service (S810), the main server 10 provides service without part or all of advertisements to the client 30 (S812).

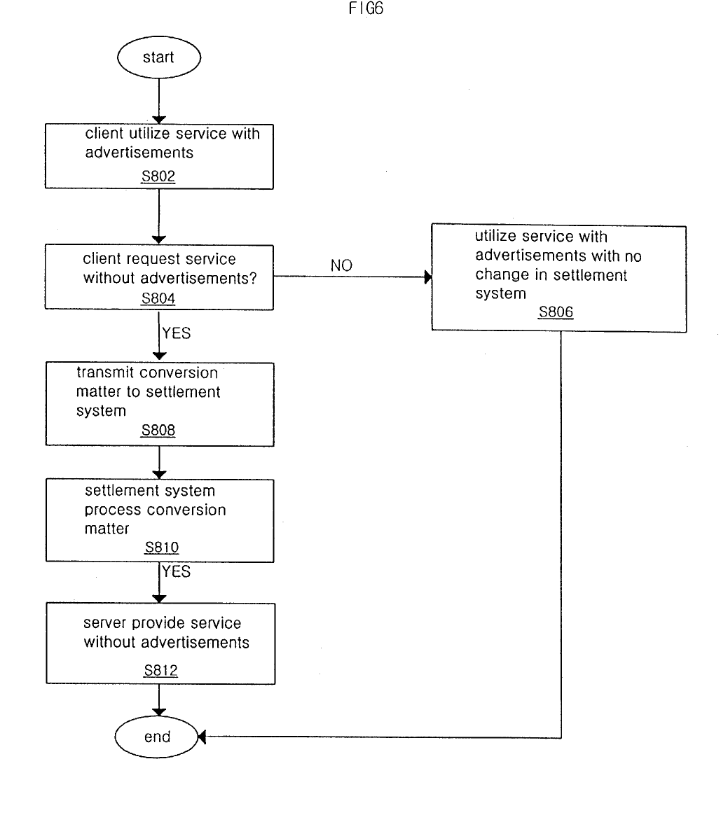

FIG. 7 is a schematic diagram showing functioning of the advertisement control module of FIG. 3.

If the client 30 logs in (1), the member DB 14 transmits member information to the service DB 16 (3). The service DB 16 provides service to the client 30 regardless of his membership (3). The member DB 14 includes an unpaid member DB 14-1 and a paid member DB 14-2. If the client is an unpaid member, the member DB 14 transmits member information to the advertisement DB 15 (5) and allows the advertisement DB 15 to transmit advertisements to the client 30 (6).

If the client 30 is a paid member, a right to choose viewing or not viewing an advertisement is granted to the client 30 through the advertisement control module 17. Two types of processes exist according to the position of the advertisement control module 17.

In the first type, the paid member DB 14b provides paid member information to the advertisement control module 17X, and advertisements are transmitted only to the client 30 wanting to view advertisements in conjunction with the advertisement DB 15 (5X-1). On the other hand, service without part or all of advertisements is provided to the client 30 not wanting to view part or all of advertisements in conjunction with the advertisement DB 15. The advertisement module 17X exchanges the service utilization information and settlement information of the client 30 with the settlement system 20 (5X-2).

In the second type, the paid membership DB 14b provides paid membership information to the advertisement control module 17Y (5Y). The membership DB 14 provides membership information to the advertisement DB 15 (5Y-1), and the advertisement DB 15 transmits advertisements to the advertisement control module 17Y (6). The advertisement control module 17Y transmits advertisements only to the client 30 wanting to view advertisements, on the basis of paid membership information received from the paid membership DB 14-2 (7Y). The advertisement control module 17Y provides service without part or all of advertisements to the client 30 not wanting to view part or all of advertisements under its own control. The advertisement control module 17Y exchanges the service utilization information and settlement information of the client 30 with the settlement system 20 (5Y-2).

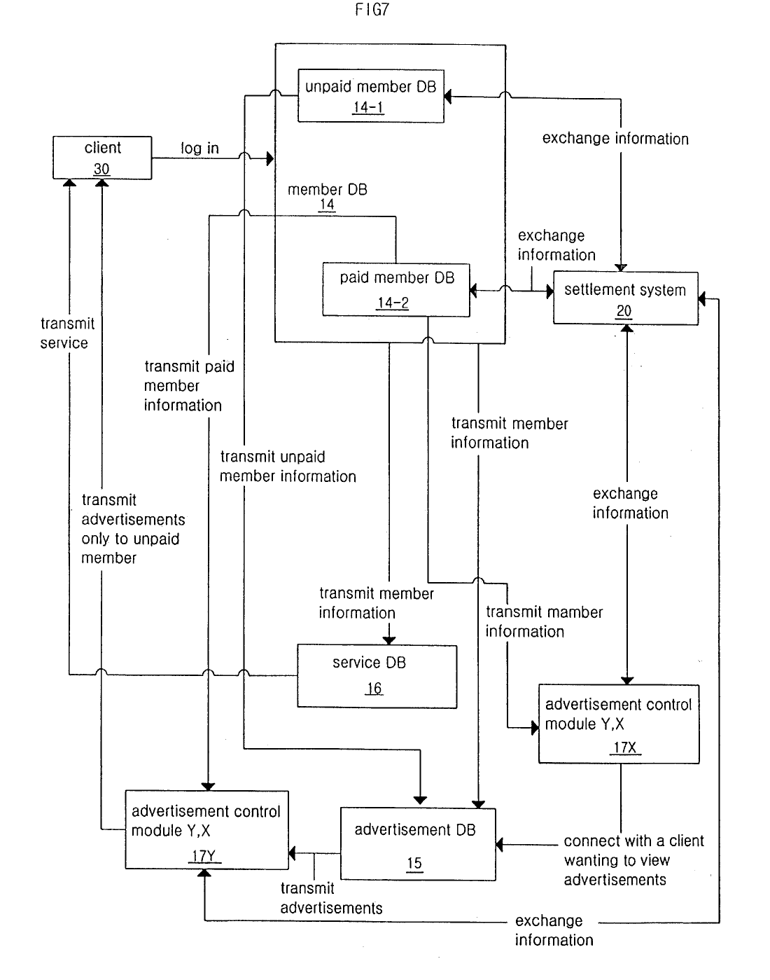

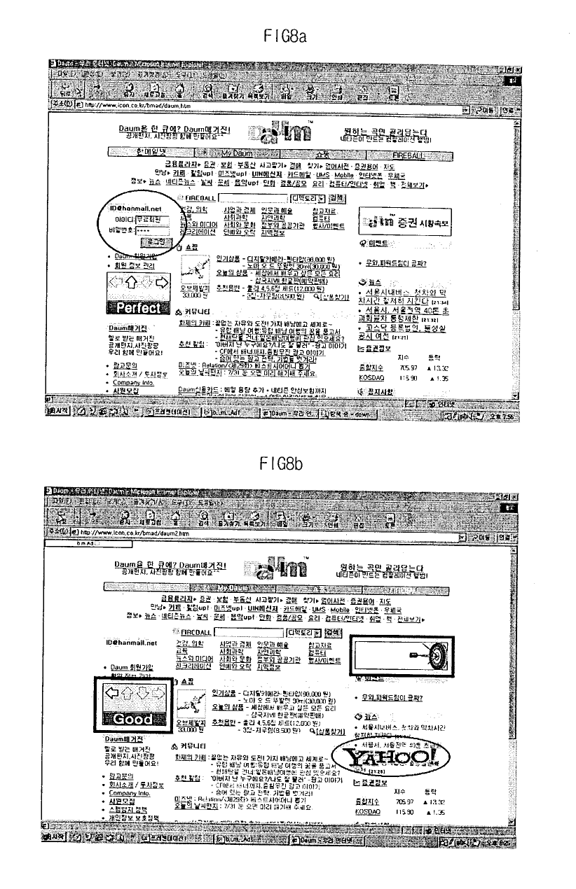

FIG. 8a is shows a log-in screen displayed at the unpaid member service utilization step of the option method of Internet advertisement subscription in accordance with an embodiment of the present invention, and FIG. 8b shows a service screen with advertisements displayed at the unpaid member service utilization step of the option method of Internet advertisement subscription in accordance with an embodiment of the present invention.

Referring to FIGS. 8a and 8b, if an unpaid member logs in, service with advertisements is provided without provision of a right to choose viewing or not viewing an advertisement.

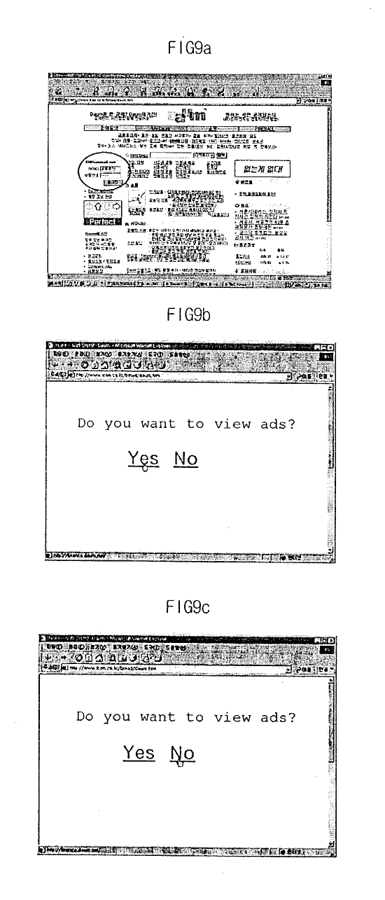

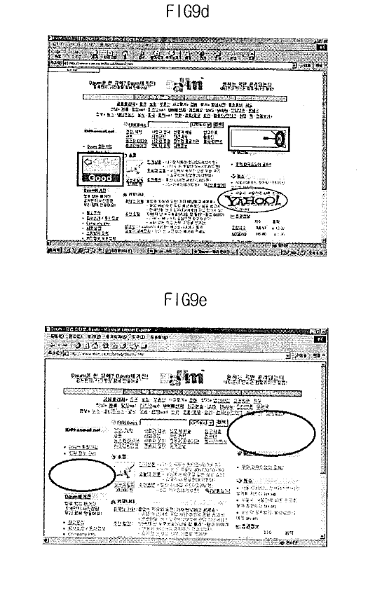

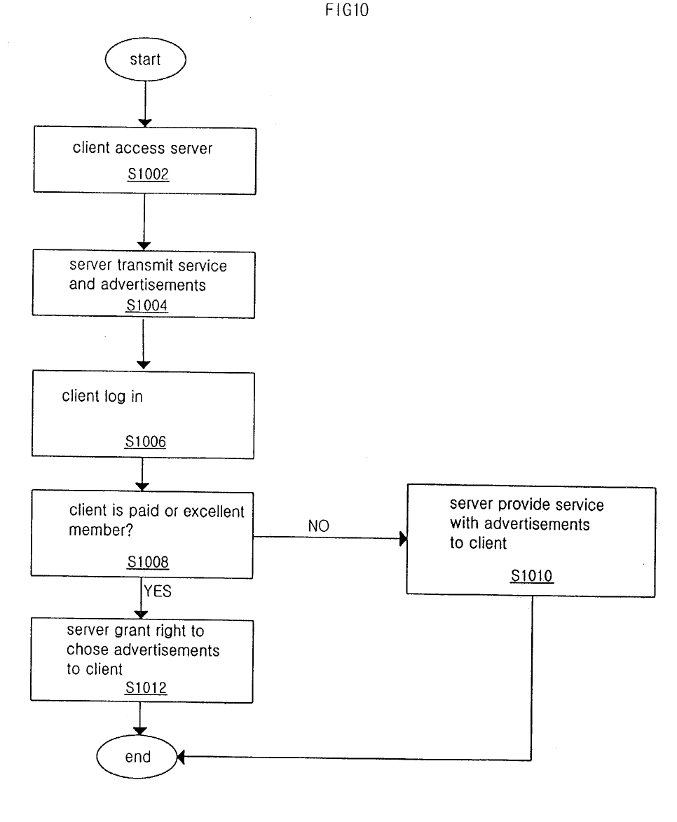

FIG. 9a shows a log-in screen displayed at the paid member service utilization step of the option method of Internet advertisement subscription in accordance with an embodiment of the present invention, FIGS. 9b and 9c show service choice screens displayed at the paid member service utilization step of the option method of Internet advertisement subscription in accordance with an embodiment of the present invention, and FIGS. 9d and 9e show service screens displayed at the paid member service utilization step of the option method of Internet advertisement subscription in accordance with an embodiment of the present invention.

If a paid member logs in as shown in FIG. 9a, service choice screens are displayed as shown in FIGS. 9b and 9c. If viewing of advertisements is chosen as shown in FIG. 9b, service with advertisements is provided as shown in FIG. 9d. On the other hand, if not viewing of advertisements is chosen as shown in FIG. 9c, service without advertisement is provided.

Embodiment 2

In this embodiment 2, if a paid member is verified through the main server and the settlement system, service without advertisement is provided without provision of a right to choose viewing or not viewing an advertisement, in contrast to embodiment 1.

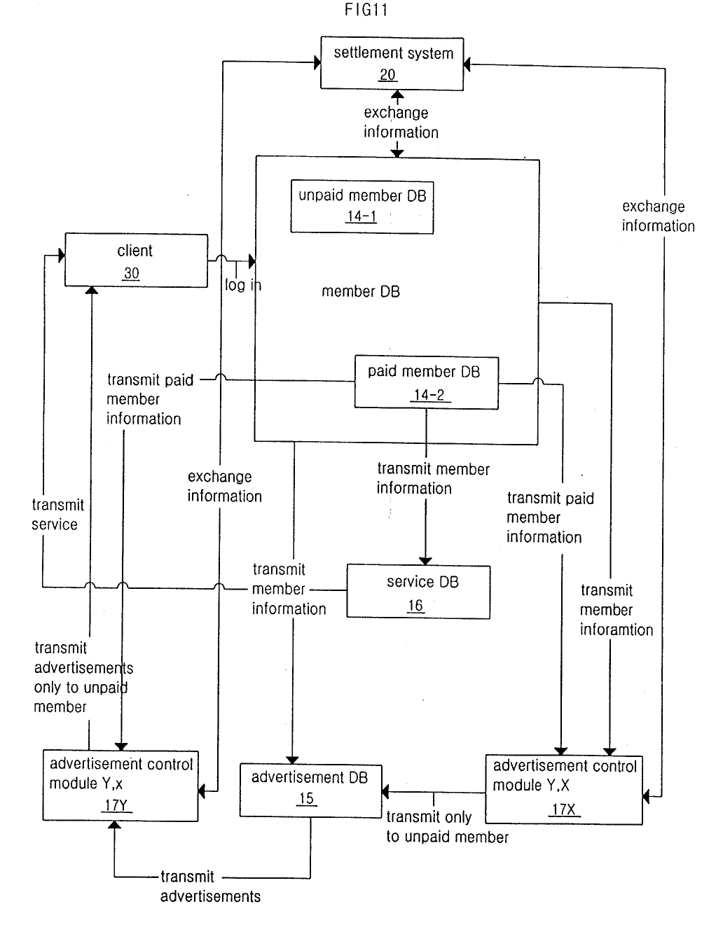

FIG. 10 is a flowchart showing the outline of an option method of Internet advertisement subscription in accordance with another embodiment of the present invention.

If the client 30 accesses the main server 10 (S1002), the main server 10 transmits service and advertisements (S 1004). If the client 30 logs in (S1006), member information of the client 30 is verified through the main server 10 and the settlement system 20. If the client 30 is confirmed to be an unpaid member (S1008), service with advertisements is provided (S1010); while service without part or all of advertisements is provided to the client 30 through the advertisement control module 17 of the main server 10 (S1012), if the client 30 is confirmed to be a paid or excellent member (S1008).

FIG. 11 is a schematic diagram showing functioning of the advertisement control module of FIG. 10.

If the client 30 logs in (1), the member DB 14 transmits member information to the service DB 16 (3). The service DB 16 provides service to the client 30 regardless of his membership (3). The member DB 14 includes an unpaid member DB 14-1 and a paid member DB 14-2. If the client is an unpaid member, the member DB 14 transmits member information to the advertisement DB 15 (5) and allows the advertisement DB 15 to transmit advertisements to the client 30 (6).

If the client 30 is a paid member, service without part or all of advertisements is provided from the advertisement control module 17. Two types of processes exist according to the position of the advertisement control module 17.

In the first type, the member DB 14 provides member information to the advertisement control module 17X, the paid member DB 14-2 provides paid member information to the advertisement control module 17X (5X-1), and advertisements are transmitted only to the client 30, who is an unpaid member, in conjunction with the advertisement DB 15 (5X-3). On the other hand, service without part or all of advertisements is provided to the client 30, who is a paid member, in conjunction with the advertisement DB 15. The advertisement module 17X exchanges the service utilization information and settlement information of the client 30 with the settlement system 20 (5X-2).

In the second type, the member DB 14 provides member information to the advertisement DB 17Y (5Y) and the paid membership DB 14b provides paid membership information to the advertisement control module 17Y (5Y-1). The advertisement DB 15 transmits advertisements to the advertisement control module 17Y (6). The advertisement control module 17Y provides service without part or all of advertisements only to the client 30 who is a paid member, on the basis of paid membership information received from the paid membership DB 14-2 (7Y). The advertisement control module 17Y provides service without part or all of advertisements to the client 30 who is a paid member, under its own control. The advertisement control module 17Y transmits advertisements only to an unpaid member 30 (7Y). The advertisement control module 17Y exchanges the service utilization information and settlement information of the client 30 with the settlement system 20 (5Y-2).

Although an option system and an option method of Internet advertisement subscription in accordance with the present invention have been described above with reference to the preferred embodiments, the scope of rights of the present invention is not limited thereto, but rather, shall be determined by the claims attached below and their equivalents, allowing various alterations, modifications, and adjustments, as those skilled in the art will understand.

What is claimed is:

1. An option system of Internet advertisement subscription, comprising:
a main server including a member database (DB) comprised of a paid member DB and an unpaid member DB for managing member information, an advertisement DB for managing advertisement programs and transmitting advertisements to clients, a service DB for managing services to be provided to clients and transmitting service, and an advertisement control module for verifying member information and controlling advertisements; and
a settlement system for managing settlement information of members through member information transmitted from said member DB of said main server, verifying said settlement information of members, and transmitting said settlement information of members to said main server;
wherein said main server and said settlement system control advertisements while they are connected to clients via a network.

2. The option system according to claim 1, wherein said clients access said main server through an access apparatus using the Internet, a Web Television network, a mobile phone network, or a similar network.

3. An option method of Internet advertisement subscription in said option system of Internet advertisement subscription, in which advertisements are controlled using a network that connects a main server, clients and a settlement system, comprising:
an accessing step, wherein a client accesses said main server;
a transmission step, wherein said main server transmits service and advertisements to said client;
a logging-in step, wherein said client inputs his information;
a verification step, wherein member information is verified in a member DB and said settlement system;
a right granting step, wherein said main server grants a right to choose viewing or not viewing of advertisements through an advertisement control module;
an advertisement choosing step, wherein said client chooses viewing or not viewing of advertisements; and
an advertisement control and service provision step, wherein said advertisement control module controls advertisements and provides service according to advertisement control request of said client.

4. The option method according to claim 3, wherein said clients access said main server through an access apparatus using the Internet, a Web Television network, a mobile phone network or a similar network.

5. The option method according to claim 3, comprising an additional step, wherein said settlement system receives fees or points corresponding to the fees for providing service with omitted advertisements upon request of paid or excellent member client for service without part or all of advertisements, and then, service without part or all of advertisements is provided to said client by said main server through said advertisement control module.

6. The option method according to claim 5, further comprising:
a service utilization step, wherein said client utilizes service without part or all of advertisements;
an advertisement re-view request step, wherein said client requests said main server for re-view of advertisements;
a changed information transmission step, wherein changed information on said client is transmitted to said settlement system;
a changed information processing step, wherein said changed information on said client is verified and processed by said settlement system; and
a service-with-advertisement provision step, wherein said main server provides service with advertisements.

7. The option method according to claim 3, further comprising:
a service utilization step, wherein said client chooses to view advertisements and utilizes service with advertisements;
an advertisement deletion request step, wherein said client requests deletion of advertisements from said main server;
a changed information transmission step, wherein changed information on said client is transmitted to said settlement system;
a changed information processing step, wherein said changed information on said client is verified and processed by said settlement system; and
a service-without-advertisement provision step, wherein said main server provides service without advertisements.

8. The option method according to claim 3, wherein said member information verification step comprises:
an information transmission step, wherein information on paid member is transmitted from said paid member DB of said member DB to said advertisement control module; and
an information exchange step, wherein said advertisement control module verifies said information on said paid member by exchanging information with said settlement system and provides processed service information to said settlement system.

9. An option method of Internet advertisement subscription in an option system of Internet advertisement subscription, in which advertisements are controlled using a network that connects a main server, clients and a settlement system, comprising:
an accessing step, wherein said client accesses said main server;
a transmission step, wherein said main server transmits service and advertisements to said client;
a logging-in step, wherein said client inputs his information;
a verification step, wherein member information is verified in a member DB of said main server and said settlement system; and
a service-without-advertisements provision step, wherein said main server provides service without part or all of advertisements to paid or excellent members through an advertisement control module.

10. The option method according to claim 9, wherein said clients access said main server through an access apparatus using the Internet, a Web Television network, a mobile phone network or a similar network.

11. The option method according to claim 9, wherein said member information verification step further comprises:
an information transmission step, wherein information on paid member is transmitted from said paid member DB of said member DB to said advertisement control module; and
an information exchange step, wherein said advertisement control module verifies said information on said paid member by exchanging information with said settlement system and provides processed service information to said settlement system.
